(19) United States
(12) Patent Application Publication
(10) Pub. No.: US 2001/0002950 A1
(43) Pub. Date: Jun. 7, 2001

(54) Exposure device for forming phosphor screen of color cathode ray tube

(76) Inventor: Hiroaki Ibuki, Kumagaya-shi (JP)

Correspondence Address: Pillsbury Madison & Sutro, LLP, East Tower, 1100 New York Avenue, N.W., Ninth Floor, Washington, DC, 20005-3918, US

(21) Appl. No.: 09/730,552

(22) Filed: Dec. 7, 2000

(30) Foreign Application Priority Data
Dec. 7, 1999 (JP) 11-347863
Sep. 26, 2000 (JP) 2000-292883

(51) Int. Cl. G03B 41/00

(52) U.S. Cl. 396/546

(57) ABSTRACT

An exposure device includes a support for supporting a panel, a light source unit for radiating a light beam onto the panel through a shadow mask, and optical lenses for correcting the trajectory of the light beam from the light source unit. The light source unit is movable between three positions corresponding individually to the positions of emission of the three electron beams from the electron gun, and is inclined when the light source unit is moved to the position corresponding to each side beam. One of the optical lenses is shaped so that a space in the pattern at an end portion of the vertical axis of the panel is changed relatively to a space in the pattern in the center of the panel when the screen forming layer is printed with the light source unit moved to the position corresponding to each side beam.

### CROSS-REFERENCE TO RELATED APPLICATIONS

This application is based upon and claims the benefit of priority from the prior Japanese Patent Applications No. 11-347863, filed Dec. 7, 1999; and No. 2000-292883, filed Sep. 26, 2000, the entire contents of which are incorporated herein by reference.

### BACKGROUND OF THE INVENTION

The present invention relates to an exposure device used for forming a phosphor screen of a color cathode-ray tube.

In general, a color cathode-ray tube comprises an envelope, which includes a panel and a funnel that is bonded to the panel. Formed on the inner surface of the panel is a phosphor screen including a light absorbing layer and three color phosphor layers, which are embedded in gaps in the light absorbing layer and glow blue, green, and red, individually. A shadow mask is opposed to the inside of the phosphor screen at a given space therefrom. The shadow mask is formed having a large number of apertures that are arranged in a given array.

A neck of the funnel contains therein an in-line electron gun, which emits three electron beams, including a center beam and a pair of side beams that pass along one and the same horizontal plane. The three electron beams emitted from the electron gun are deflected by means of a deflecting device that is mounted on the outside of the funnel, and scan the phosphor screen horizontally and vertically through the shadow mask, thereby displaying a color image.

In the case of a high-precision color cathode-ray tube that is used in terminal equipment for information processing, in particular, the apertures of the shadow mask are circular, and the phosphor screen, corresponding to the apertures, is in the form of a dot matrix designed so that the three color phosphor layers, each in the form of a circular dot, are embedded in circular matrix holes in the matrix-shaped light absorbing layer.

The matrix-shaped phosphor screen of this type is formed in the following processes.

First, a sensitizer is applied to the inner surface of the panel and dried to form a photosensitive resist layer thereon. After the shadow mask is then attached to the panel, the panel is set on a support of an exposure device. The photosensitive resist layer is exposed through the shadow mask to exposure light that is emitted from a light source of the exposure device. Thereupon, a pattern corresponding to the circular apertures of the shadow mask is printed on the resist layer.

Subsequently, the photosensitive resist layer is developed and unexposed portions are removed, whereupon a resist is formed as a circular dot pattern. Then, a black paint is applied to the inner surface of the panel, having the resist thereon, and is dried, whereupon a black paint layer is formed on the resist. Then, the black paint layer on the resist is separated together with the resist, whereupon the light absorbing layer is formed on the inner surface of the panel, having matrix holes corresponding to regions from which the resist is removed.

Thereafter, a photosensitive phosphor slurry, consisting mainly of a sensitizer, phosphor, etc., is applied to the inner surface of the panel, having the light absorbing layer thereon, and is dried, whereupon a photosensitive phosphor slurry layer is formed. After the shadow mask is attached to the panel, the panel is set on the support of the exposure device. Then, the photosensitive phosphor slurry layer is exposed through the shadow mask to exposure light that is emitted from the light source of the exposure device. Thereupon, the pattern corresponding to the apertures of the shadow mask is printed on the slurry layer.

Subsequently, the photosensitive phosphor slurry layer, having the pattern printed thereon, is developed, and unexposed portions are removed. Thereupon, a circular dot-shaped phosphor layer, e.g., a blue phosphor layer, is formed in a predetermined matrix hole of the light absorbing layer. Thereafter, the same processes for forming the blue phosphor layer are repeated for a green phosphor and a red phosphor, whereupon the phosphor screen is formed.

The exposure device that is used to form this phosphor screen is provided with a support for positioning and supporting the panel. A light source unit for radiating a light beam for printing the pattern corresponding to the apertures of the shadow mask is arranged under the support for movement with respect to the inner surface of the panel. Arranged between the light source unit and the panel that is supported by means of the support, moreover, are an optical lens system and a light distribution filter for adjusting light distribution on the inner surface of the panel. The optical lens system includes a ΔS correcting lens, which serves to approximate the trajectory of the light beam that is radiated from the light source unit to those of the electron beams emitted from the electron gun of the color cathode-ray tube, and a γ−ΔP correcting lens, which serves to correct distortion that is attributable to the movement of the center of deflection.

In forming the light absorbing layer, the light source unit is moved to a position corresponding to one of the three electron beams emitted from the electron gun, and the layer is exposed for a given period of time. This process is repeated successively for three positions that correspond to the three electron beams. In forming each of the three color phosphor layers, on the other hand, the light source is moved to a position corresponding to one side beam (red electron beam) for the red phosphor layer, a position corresponding to the center beam (green electron beam) for the green phosphor layer, or a position corresponding to the other side beam (blue electron beam) for the blue phosphor layer so that each phosphor layer is exposed.

When printing the pattern with the light source situated corresponding to the center beam, in any case, the ΔS correcting lens, γ−ΔP correcting lens, and light distribution filter are located so that their respective central axes are in line with the central axis of the panel that is supported on the support. In the case where the light source is moved to the position corresponding to each side beam before the pattern is printed, on the other hand, the γ−ΔP correcting lens is moved for a given distance for exposure in the same direction as the movement of the light source unit.

In the case of a high-precision color cathode-ray tube, compared with a conventional color cathode-ray tube, the electron beams are expected to be landed on the phosphor layers with higher accuracy in consideration of important image characteristics, such as white uniformity, brightness uniformity, etc.

In an in-line color cathode-ray tube, in general, the deflecting device is provided with various correction devices for correcting image distortion. NS magnets are frequently used to correct pincushion NS distortions at the ends of the vertical axis of an image. With use of the NS magnets, the horizontal angle of incidence of the pair of side beams increases near the ends of the vertical axis of the image, so that the space between the pair of side beams becomes longer than in the central portion of the image. Since a landing error is then caused, it is to be desired that a phosphor screen should be formed such that the landing error can be corrected in advance.

On the other hand, each correcting lens of the exposure device is designed in accordance with a lens design program so that the landing position of each electron beam on the inner surface of the panel is coincident with that of the light beam from the light source unit. Normally, the γ−ΔP correcting lens is common to the three electron beams, and the ΔS correcting lens is used for fine landing correction for the pair of side beams. Correcting lenses that are formed of a continuous curved surface each are frequently used in consideration of workability and costs.

Although a correcting lens formed of a continuous curved surface can be designed so that landing errors in the radial direction of the phosphor screen can be corrected with high accuracy, however, it is hard to design it so that lateral errors that are perpendicular to the radial direction can be accurately corrected. Even if the ΔS correcting lens is designed so that local landing errors for the pair of side beams can be corrected, in particular, landing errors remain in a direction such that the beams disperse in the rotating direction for each of the four quadrants of the picture when the pattern corresponding to the apertures of the shadow mask is printed with the light source unit in the position corresponding to the one side beam. Thus, the landing errors cannot be corrected entirely. It is difficult, therefore, to form a phosphor screen such that landing errors attributable to an increased space SV between the pair of side beams near the vertical axis of the aforesaid picture can be corrected satisfactorily. This is an unfavorable factor to image characteristics.

### BRIEF SUMMARY OF THE INVENTION

The present invention has been contrived in consideration of these circumstances, and its object is to provide an exposure device for forming a phosphor screen of a color cathode-ray tube, capable of forming a phosphor screen such that landing errors of a pair of side beams can be corrected.

In order to achieve the above object, according to the present invention, there is provided an exposure device for forming a phosphor screen of a color cathode-ray tube, which includes a panel having a phosphor screen formed on an inner surface thereof, the panel having a central axis, a horizontal axis and a vertical axis that extend at right angles to the center axis and to each other; a shadow mask opposed to the phosphor screen and having a large number of apertures; and an electron gun for emitting three electron beams, including a center beam and a pair of side beams arranged in a line on either side thereof, toward the phosphor screen through the shadow mask. The device comprises: a panel support portion for supporting a panel having a photosensitive phosphor screen forming layer formed on the inner surface thereof and fitted with the shadow mask; a light source unit for radiating a light beam toward the inner surface of the panel supported by the panel support portion through the shadow mask and printing a pattern corresponding to the apertures of the shadow mask on the photosensitive phosphor screen forming layer, the light source unit being movable between three positions corresponding individually to the positions of emission of the three electron beams from the electron gun with respect to the panel; and a plurality of optical lenses arranged between the light source unit and the shadow mask attached to the panel supported by the support portion and capable of correcting the trajectory of the light beam radiated from the light source unit so as to be in line with the respective trajectories of the three electron beams. The light source unit is inclined in a direction such that a portion of the light source unit on the side of the central axis of the panel approaches the panel when the light source unit is moved to the position corresponding to each side beam. One of the optical lenses is shaped so that a space in the pattern at end portions of the vertical axis of the panel is changed relatively to a space in the pattern in the center of the panel when the photosensitive phosphor screen forming layer is printed with the light source unit moved to the position corresponding to each side beam.

According to the color cathode-ray tube with the phosphor screen formed by means of the exposure device constructed in this manner, the landing errors of the electron beams can be corrected and minimized in the entire screen, and landing errors that are attributable to the increased space between the pair of side beams near the end portion of the vertical axis can be also corrected effectively.

Thus, the optical lens is appropriately designed by utilizing the convergence properties of a correcting lens that is formed of a continuous curved surface, as mentioned before, and the light source unit is inclined within a given angular range. By doing this, a phosphor screen can be formed such that the landing errors that are attributable to the increased space between the pair of side beams at the end of the vertical axis of the picture, as well as the landing error in the rotating direction, can be corrected substantially thoroughly. Thus, the landing errors of the side beams can be corrected optimally, whereby a color cathode-ray tube can be realized that ensures outstanding image characteristics, such as white uniformity, brightness uniformity, etc., and a generous landing allowance for earth magnetism.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a sectional view showing an in-line color cathode-ray tube provided with a phosphor screen formed by means of an exposure device according to an embodiment of the invention;

FIG. 2A is an enlarged plan view showing a part of the phosphor screen of the color cathode-ray tube shown in FIG. 1;

FIG. 2B is a sectional view taken along line IIB-IIB of FIG. 2A;

FIG. 3 is a sectional view showing the exposure device of the embodiment;

FIG. 4A is a side view showing a light source unit of the exposure device;

FIG. 4B is a plan view of the light source unit;

FIG. 5A is a side view showing the light source unit moved to a position corresponding to one side beam;

FIG. 5B is a side view showing the light source unit moved to a position corresponding to the other side beam;

FIG. 6A is a sectional view of the exposure device with the light source unit in a position corresponding to a center beam;

FIG. 6B is a sectional view of the exposure device with the light source unit in the position corresponding to the one side beam;

FIG. 6C is a sectional view of the exposure device with the light source unit in the position corresponding to the other side beam;

FIGS. 7A to 7G are sectional views schematically showing processes for forming the phosphor screen;

FIG. 8 is a plan view schematically showing a state of displacement of a pattern formed during exposure;

FIG. 9A is a contour line map of a ΔS correcting lens for correcting rotation errors with the same M46, which is designed by a conventional design method;

FIG. 9B is a contour line map of a ΔS correcting lens for correcting rotation errors with the same M46, which is designed by a design method according to the present embodiment;

FIG. 9C is a contour line map showing a ΔS correcting lens for correcting rotation errors about 1.5 times as great as the aforesaid ones, which is designed by the conventional design method;

FIG. 9D is a contour line map showing a ΔS correcting lens for correcting rotation errors about 1.5 times as great as the aforesaid ones, which is designed by the design method according to the invention embodiment;

FIG. 10A is a diagram showing landing errors caused when a conventional phosphor screen is used; and

FIG. 10B is a diagram showing landing errors caused when the phosphor screen formed by means of the exposure device according to the embodiment is used.

### DETAILED DESCRIPTION OF THE INVENTION

An exposure device for phosphor screen formation according to an embodiment of the present invention will now be described in detail with reference to the accompanying drawings.

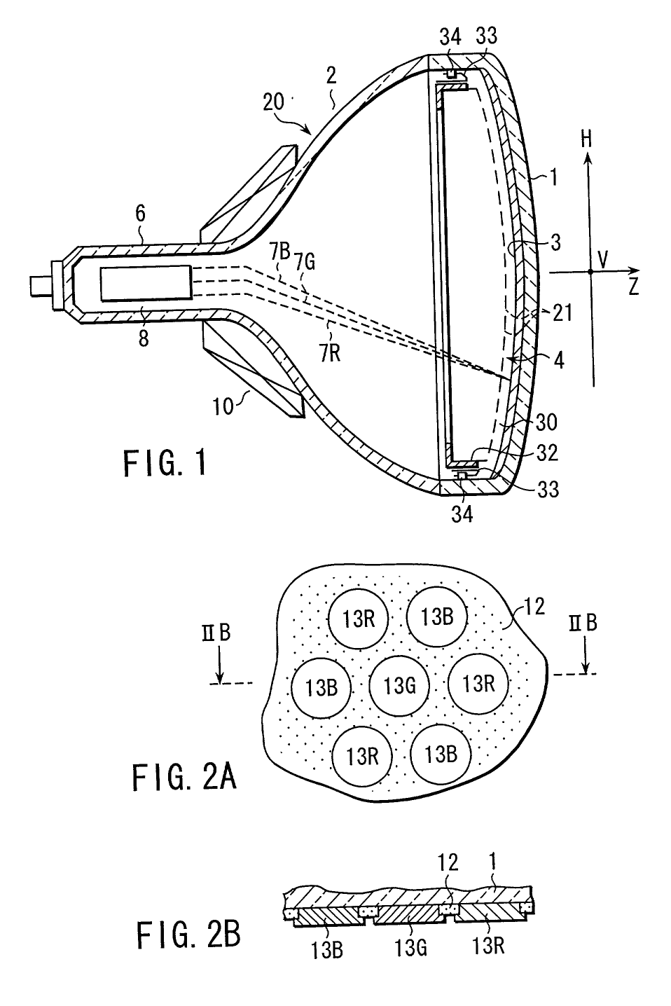

An in-line color cathode-ray tube with a phosphor screen that is formed by means of the exposure device will be described first. As shown in FIG. 1, the color cathode-ray tube comprises an envelope 20, which includes a panel 1 and a funnel 2 that is bonded to a skirt portion of the panel. The panel 1, which is substantially rectangular, has a horizontal axis H and a vertical axis V that extend at right angles to a tube axis Z or a central axis and to each other. A phosphor screen 3 is formed on the inner surface of the panel 1.

As shown in FIGS. 2A and 2B, the phosphor screen 3 includes a black light absorbing layer 12 and three color phosphor layers 13B, 13G and 13R, which are embedded in gaps in the black layer 12 and glow blue, green, and red, respectively. In a high-precision color cathode-ray tube, apertures of a shadow mask (mentioned later) are circular, and the phosphor screen 3, corresponding to the apertures, is in the form of a dot matrix designed so that the three color phosphor layers 13B, 13G and 13R, each in the form of a circular dot, are embedded in circular matrix holes in the matrix-shaped light absorbing layer 12.

In the vacuum envelope 20, as shown in FIG. 1, a shadow mask 4 is opposed to the phosphor screen 3 at a given space therefrom. The shadow mask 4 includes a substantially rectangular mask body 30, which has a large number of apertures 21 formed in a given array, and a mask frame 32 that supports the peripheral edge portion of the mask body. The shadow mask 4 is removably attached to the panel 1 in a manner such that a plurality of elastic holders 33, e.g., four in number, fixed to the mask frame 32 are individually in engagement with stud pins 34 that protrude from the inner surface of the skirt portion of the panel 1.

A neck 6 of the funnel 2 contains therein an in-line electron gun 8, which emits three electron beams, including a center beam 7G and a pair of side beams 7B and 7R that are arranged in a line in the horizontal direction. In the color cathode-ray tube, the three electron beams emitted from the electron gun 8 are deflected by means of a deflecting device 10 that is attached to the outside of the funnel 2, and a color image is displayed by scanning the phosphor screen 3 horizontally and vertically through the shadow mask 4.

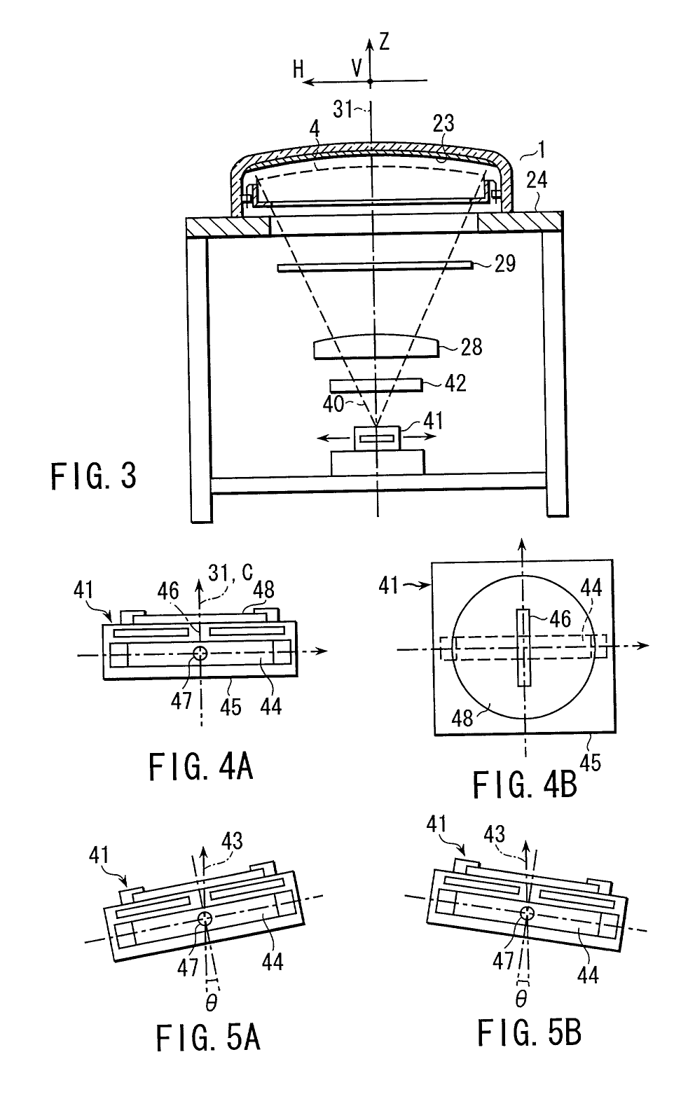

The following is a description of the exposure device according to the present embodiment for forming the phosphor screen of the in-line color cathode-ray tube described above. As shown in FIG. 3, the exposure device is provided with a support 24 for positioning and supporting the panel 1, the inner surface of which is coated with a photosensitive phosphor screen forming layer 23, such as a photosensitive resist film for forming the light absorbing layer 12 or a photosensitive phosphor slurry layer for forming a the three color phosphor layers, and is fitted with the shadow mask 4. A light source unit 41 for radiating a light beam toward the inner surface of the panel 1 on the support 24 is provided on the lower part of the support 24. Arranged between the light source unit 41 and the shadow mask 4 attached to the panel 1 that is positioned and supported by means of the support 24, moreover, are optical lenses, such as a ΔS correcting lens 42, γ−ΔP correcting lens 28, etc., and a light distribution filter 29 for adjusting light distribution on the inner surface of the panel 1, in the order named.

The light source unit 41 radiates a light beam 40, thereby printing a pattern corresponding to the apertures 21 of the shadow mask 4 on the photosensitive phosphor screen forming layer 23. As shown in FIGS. 4A and 4B, the light source unit 41 includes a tubular light source 44 such as an extra-high pressure mercury lamp, a lamp house 45 in the form of a substantially rectangular box that holds the tubular light source, a slit 46 formed on the lamp house 45 for adjusting the amount of light, and a cover glass 48 fixed on the lamp house 45 so as to cover the slit 46 and transmitting the light beam. The lamp house 45 has a liquid-tight structure and a coolant is always circulated in the house 45 so as to cool the tubular light source 44. The light source unit 41 can rock for a given angle around a rotating shaft 47. Further, the light source unit 41 is arranged so that the slit 46 and the shaft 47 are situated parallel to the vertical axis V of the panel 1 that is supported on the support 24.

Furthermore, the light source unit 41 is located so that the position for the emission of the light beam 40 toward the photosensitive phosphor screen forming layer 23 is coincident with the position for the emission of the light beams from the electron gun 8 as the color cathode-ray tube is formed using the panel 1. The light source unit 41 is movable between three positions that correspond individually to the center and side beams that are emitted from the electron gun 8 of the in-line color cathode-ray tube.

The positions that correspond to the center and side beams are positions close to the positions through which the center and side beams pass at the screen-side end portion of the electron gun 8 of the in-line color cathode-ray tube, as mentioned before.

When the light source unit 41 is located at the position corresponding to the center beam, as shown in FIG. 4A, its central axis c is situated in alignment with the tube axis Z or a central axis 31 of the panel 1 that is positioned and supported on the support 24 and the light source unit is located on a horizontal plane perpendicular to the central axis 31 of the panel. When the light source unit 41 is moved to the position corresponding to one of the side beams, as shown in FIG. 5A or 5B, it is rocked around the rotating shaft 47 to be inclined so that its end portion on the side of the central axis 31 of the panel 1 that is positioned and supported on the support 24 approaches the panel 1. An angle θ of the inclination is adjusted to 1°to 5°to a vertical line 43 that extends parallel to the central axis 31 of the panel 1.

On the other hand, the ΔS correcting lens 42 is used to approximate the trajectory of the light beam 40 that is radiated from the light source unit 41 to those of the pair of side beams emitted from the electron gun 8 of the color cathode-ray tube, while the γ−ΔP correcting lens 28 serves for correction that accompanies the movement of the center of deflection of the light beam 40. As mentioned later, the ΔS correcting lens 42 is designed to have a curved surface that is different from that of a conventional ΔS correcting lens.

The following is a description of processes for forming the phosphor screen by means of the exposure device constructed in this manner.

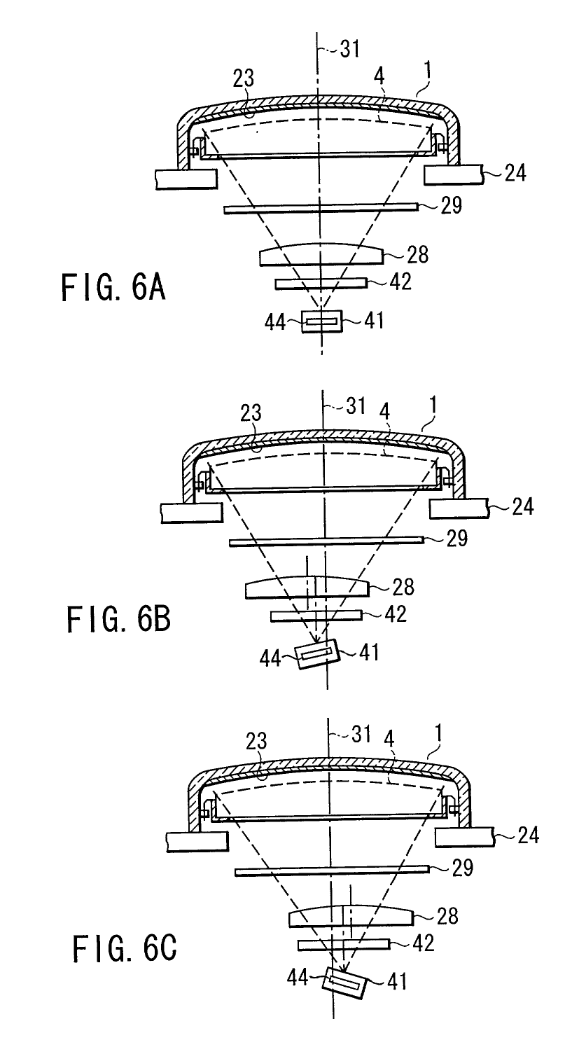

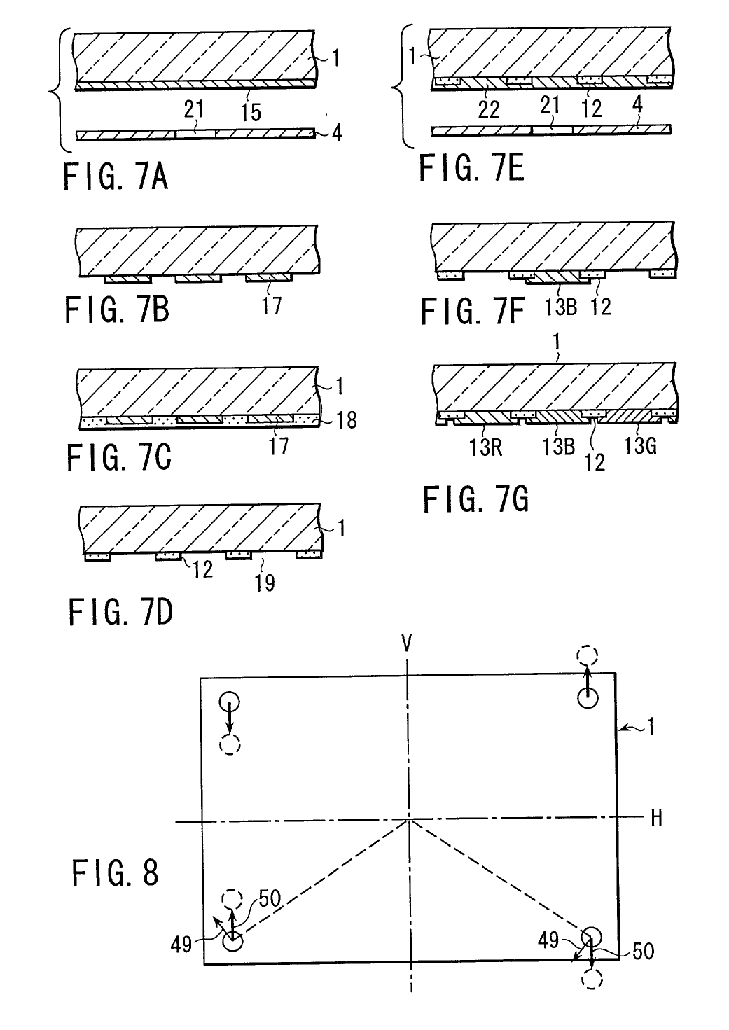

As shown in FIGS. 6A and 7A, a sensitizer is applied to the inner surface of the panel 1 and dried to form a photosensitive resist film 15 thereon. After the shadow mask 4 is then attached to the panel 1, the panel 1 is set on the support 24 of the exposure device. In this state, the light beam 40 is radiated from the light source unit 41, and the photosensitive resist film 15 is exposed through the shadow mask 4. Thereupon, the pattern corresponding to the circular apertures 21 of the shadow mask 4 is printed on the resist film 15.

In doing this, the photosensitive resist film 15 is exposed for a given period of time with the light source unit 41 situated corresponding to the center beam. Thereafter, the light source unit 41 is moved to a position corresponding to one of the side beams, as shown in FIG. 6B, and the photosensitive resist film 15 is exposed for another given period of time. Further, the light source unit 41 is moved to a position corresponding to the other side beam, and the resist film 15 is exposed for still another given period of time.

Subsequently, the panel 1 is disengaged from the exposure device, and the photosensitive resist film 15, having the pattern printed thereon, is developed, and unexposed portions are removed. Thereupon, a resist 17 is formed as a circular dot pattern, as shown in FIG. 7B.

Then, a black paint is applied to the inner surface of the panel 1, having the resist 17 thereon, and is dried, whereupon a black paint layer 18 is formed on the resist 17, as shown in FIG. 7C. Further, the black paint layer 18 on the resist 17 is separated together with the resist 17, whereupon the matrix-shaped light absorbing layer 12 is formed on the inner surface of the panel 1, having matrix holes 19 corresponding to regions from which the resist is removed, as shown in FIG. 7D.

Thereafter, a photosensitive phosphor slurry, consisting mainly of a sensitizer, phosphor, etc., is applied to the inner surface of the panel 1, having the light absorbing layer 12 thereon, and is dried, whereupon a photosensitive phosphor slurry layer 22 is formed, as shown in FIG. 7E. The shadow mask 4 is attached again to the panel 1, which is then set on the support 24 of the exposure device.

Subsequently, the light beam 40 is radiated from the light source unit 41, and the photosensitive phosphor slurry layer 22 is exposed through the shadow mask 4. Thereupon, the pattern corresponding to the circular apertures 21 of the shadow mask 4 is printed on the slurry layer 22. Thereafter, the panel 1 is disengaged from the exposure device, and the photo-sensitive phosphor slurry layer 22, having the pattern printed thereon, is developed, and unexposed portions are removed. Thereupon, a circular dot-shaped phosphor layer, e.g., a blue phosphor layer 13B, is formed in a predetermined matrix hole of the light absorbing layer 12, as shown in FIG. 7F.

Further, the same method of forming the blue phosphor layer 13B is repeated for a green phosphor 13G and a red phosphor 13R in succession. Thus, a green phosphor layer 13G and a red phosphor layer 13R, each in the form of a circular dot, are formed individually in predetermined matrix holes of the light absorbing layer 12, as shown in FIG. 7G.

In forming each of the three color phosphor layers 13R, 13B and 13G, the light source unit 41 is moved to a position corresponding to the one side beam (red electron beam) for the red phosphor layer 13R, a position corresponding to the center beam (green electron beam) for the green phosphor layer 13G, or a position corresponding to the other side beam (blue electron beam) for the blue phosphor layer 13B so that each phosphor layer is exposed.

When printing the pattern with the light source unit 41 situated corresponding to the center beam in the case where the light absorbing layer 12 or each phosphor layer is exposed, the ΔS correcting lens 42, γ−ΔP correcting lens 28, and light distribution filter 29 are located so that their respective central axes are in line with the central axis 31 of the panel 1 that is supported on the support 24, as shown in FIG. 6A. In the case where the light source unit 41 is moved to the position corresponding to each side beam before the pattern is printed, on the other hand, the ΔS correcting lens 42 and the γ−ΔP correcting lens 28 are moved for given distances for exposure in the same direction as the movement of the light source unit 41.

According to the exposure device constructed in this manner, the phosphor screen with satisfactory image characteristics can be formed in a manner such that landing errors that are caused by an increased space between the pair of side beams near an end of the vertical axis V of the panel are corrected effectively.

More specifically, the light source unit 41 is moved to the position corresponding to the one side beam (red electron beam) on the left-hand side of FIG. 6B and is inclined at the angle θ. Further, the movement of the light source unit 41 is adjusted so that the displacement of the light beam from the light source unit 41, compared with the aforesaid side beam, is reduced zero at an end of a horizontal axis H of the inner surface of the panel 1. In other words, the movement of the light source unit 41 is adjusted so that the pattern (exposed portion) formed corresponding to the apertures 21 of the shadow mask 4 is coincident with the landing position of the one side beam at the end of the horizontal axis H. Thereupon, the exposed portion of the photosensitive phosphor screen forming layer, formed corresponding to the apertures 21 of the shadow mask 4, is displaced in a direction 50 that includes a lateral component 49 with respect to the one side beam, in any other portion than the horizontal axis H and the vertical axis V of the inner surface of the panel 1, as shown in FIG. 8.

The ΔS correcting lens 42 is designed in this state. Thereupon, the exposed portion can be moved in the same direction with the landing error in the rotating direction to be corrected. Further, the landing correction value changes depending on the angle θ of inclination of the light source unit 41. Therefore, the landing error in the rotating direction can be minimized by designing the ΔS correcting lens so that the lamp house inclination angle θ can be changed according to the value of the landing error.

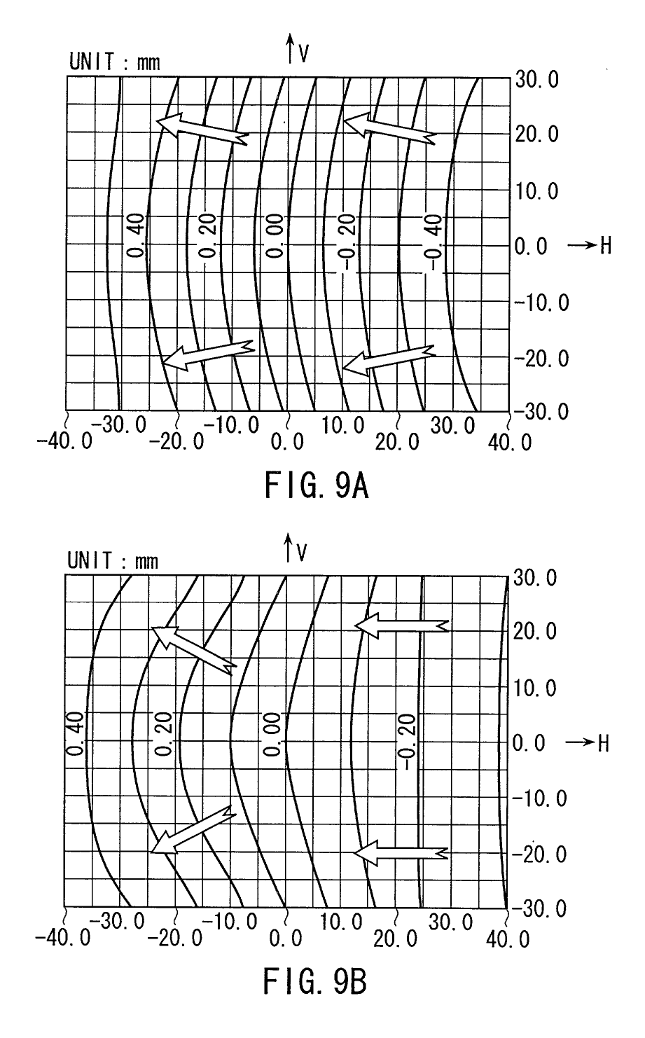

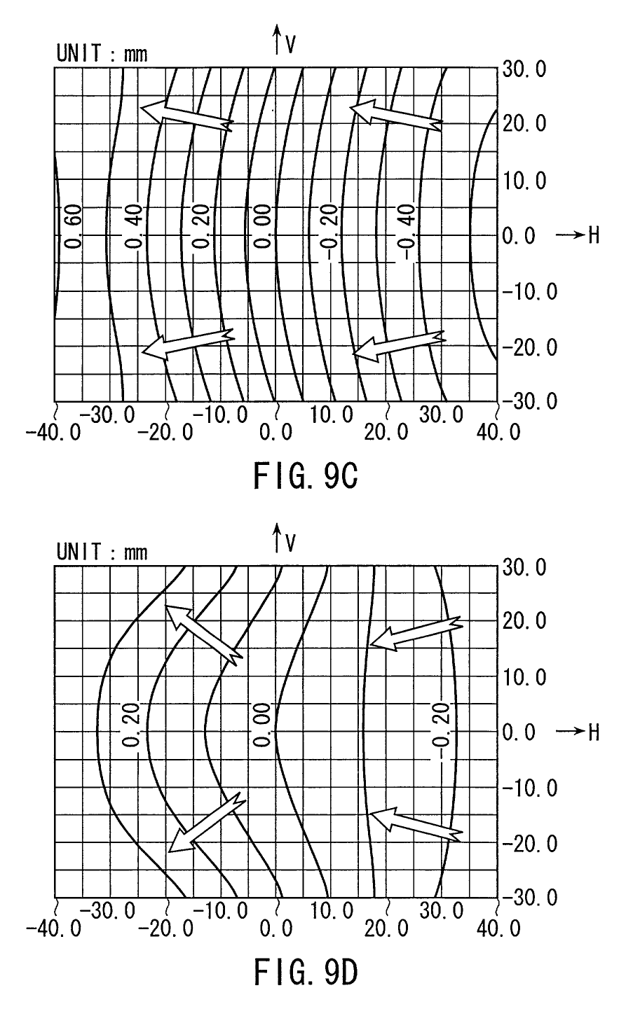

FIGS. 9A and 9B are contour line maps of the ΔS correcting lenses 42 for correcting rotation errors with the same M46, which are designed by a conventional design method and a design method according to the present invention, respectively. FIGS. 9C and 9D are contour line maps showing the ΔS correcting lenses 42 for correcting rotation errors about 1.5 times as great as the aforesaid ones, which are designed by the conventional design method and the design method according to the invention, respectively.

As shown in FIGS. 9A and 9B and FIGS. 9C and 9D that are given for comparison, any of the ΔS correcting lenses 42 is formed flat in a manner such that its inclination becomes greater with distance from the horizontal axis H near the corner at its negative end and becomes greater as the axis H is approached near the corner at its positive end.

In practice, the conventional ΔS correcting lenses can be used without hindrance only if the landing error in the rotating direction can be corrected with the inclination angle θ of about 1°. Even in the case of a large-sized tube that is subject to a doubled landing error in the rotating direction, a phosphor screen with a low enough landing error can be formed with use of the inclination angle of about 5°. Thus, the landing errors of substantially all color cathode-ray tubes can be lowered satisfactorily with use of inclination angles ranging from 1° to 5°.

In the case where the light source unit 41 is moved to the position corresponding to the other side beam (blue electron beam) on the right-hand side of FIG. 6C and inclined, the landing error in the rotating direction can be reduced by rotating the ΔS correcting lens 42 for 180°, since the two side beams are symmetrical with respect to the vertical axis V.

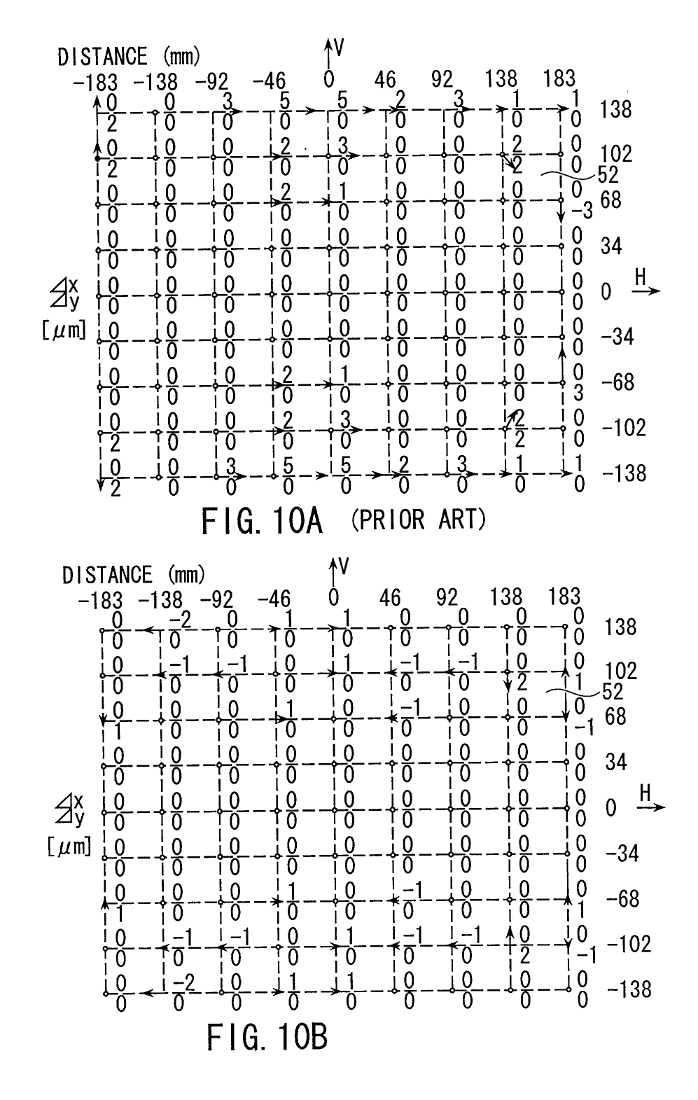

FIGS. 10A and 10B comparatively show landing errors that are caused when the conventional phosphor screen and the phosphor screen formed by means of the exposure device of the present embodiment are applied to 19-inch color cathode-ray tubes (M46 tubes), respectively. FIG. 10A shows landing errors that are caused when the phosphor screen is designed by using the conventional ΔS correcting lens in a manner such that the pattern corresponding to the apertures of the shadow mask is printed with the light source unit moved to the position corresponding to the one side beam without being inclined. FIG. 10B shows landing errors that are caused when the phosphor screen is designed by using the newly designed ΔS correcting lens 42 of the present embodiment in a manner such that the light source unit is moved to the position corresponding to the one side beam on the left-hand side and inclined properly.

In these drawings, arrows 52 on the points of intersection of horizontal and vertical broken lines indicate the respective directions of landing errors caused on the intersecting points, and the figures over and below the horizontal broken lines indicate the values (μm) of horizontal and vertical components, respectively, of the landing errors on the intersecting points.

According to the color cathode-ray tube with the phosphor screen formed by means of the exposure device of the present embodiment, as seen from FIGS. 10A and 10B, the landing errors of the entire screen can be corrected and minimized, and landing errors that are attributable to the increased space between the pair of side beams near the end of the vertical axis V can be also corrected effectively.

Thus, the ΔS correcting lens 42 is appropriately designed by utilizing the convergence properties of a correcting lens that is formed of a continuous curved surface, and the light source unit is inclined within the range of 1° to 5°. By doing this, a phosphor screen can be formed such that the landing errors that are attributable to the increased space between the pair of side beams at the end of the vertical axis V of the picture, as well as the landing error in the rotating direction, can be corrected substantially thoroughly. Thus, the landing errors of the side beams can be corrected optimally, whereby a color cathode-ray tube can be realized that ensures outstanding image characteristics, such as white uniformity, brightness uniformity, etc., and a generous landing allowance for earth magnetism.

The present invention is not limited to the embodiment described above, and various changes or modifications can be effected therein by one skilled in the art without departing from the scope or sprit of the invention. According to the above-described embodiment, for example, the landing errors are corrected by means of the combination of the inclination of the light source unit and the ΔS correcting lens. Alternatively, however, a color cathode-ray tube with better image characteristics can be manufactured in a manner such that the space between the pair of side beams is made more appropriate by slightly changing the shape of the shadow mask, thereby adjusting the distance (value g) between the inner surface of the panel and the shadow mask.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An exposure device for forming a phosphor screen of a color cathode-ray tube, which includes a panel having a phosphor screen formed on an inner surface thereof, the panel having a central axis, a horizontal axis and a vertical axis that extend at right angles to the center axis and to each other; a shadow mask opposed to the phosphor screen and having a large number of apertures; and an electron gun for emitting three electron beams, including a center beam and a pair of side beams arranged in a line on either side thereof, toward the phosphor screen through the shadow mask, the device comprising:
a panel support portion for supporting a panel having a photosensitive phosphor screen forming layer formed on the inner surface thereof and fitted with the shadow mask;
a light source unit for radiating a light beam toward the inner surface of the panel supported by the panel support portion through the shadow mask and printing a pattern corresponding to the apertures of the shadow mask on the photosensitive phosphor screen forming layer, the light source unit being movable between three positions corresponding individually to the positions of emission of the three electron beams from the electron gun with respect to the panel; and
a plurality of optical lenses arranged between the light source unit and the shadow mask attached to the panel supported by the support portion and capable of correcting the trajectory of the light beam radiated from the light source unit so as to be in line with the respective trajectories of the three electron beams,
wherein the light source unit is inclined in a direction such that a portion of the light source unit on the side of the central axis of the panel approaches the panel when the light source unit is moved to the position corresponding to each side beam, and
one of the optical lenses is shaped so that a space in the pattern at end portions of the vertical axis of the panel is changed relatively to a space in the pattern in the center of the panel when the photosensitive phosphor screen forming layer is printed with the light source unit moved to the position corresponding to each side beam.

2. An exposure device according to claim 1, wherein the light source unit is inclined at 1°to 5° when moved to the position corresponding to each side beam.

3. An exposure device according to claim 1, wherein said one optical lens is shaped so that landing errors of the light beam are minimized for the light source unit situated inclined in the position corresponding to one of the side beams.

4. An exposure device according to claim 1, wherein said plurality of optical lenses include a ΔS correcting lens and a γ−ΔP correcting lens arranged successively following the light source unit, the ΔS correcting lens corresponding to the one optical lens.

5. An exposure device according to claim 4, wherein said ΔS correcting lens and said γ−ΔP correcting lens are movable in the same direction with the light source unit when the light source unit is moved to the position corresponding to each side beam.
